(19) United States
(12) Patent Application Publication
(10) Pub. No.: US 2011/0308424 A1
(43) Pub. Date: Dec. 22, 2011

(54) Single-Coat Self-Priming Anticorrosion Composition

(76) Inventors: Robert Rotondi, Port Washington, NY (US); Lado V. Goudjabidze, Flushing, NY (US)

(21) Appl. No.: 11/955,403

(22) Filed: Dec. 13, 2007

(51) Int. Cl. C09D 5/08

(52) U.S. Cl. 106/14.11; 106/14.41; 106/14.44

(57) ABSTRACT

An elastomer agent coating combines silicone base compound ingredients for viscose mass, curing agents, and metallic coloring powders. It may be diluted or thickened depending on solvent agents. Metallic powder coloring ingredients are used in a plurality of shades in various combinations to produce alternately semi-transparent coatings, clear coatings, and solid color coatings in different shades and colors. Color additives are used to create a multi-variety of singular color appearance to detect uncoated areas to assist in creating a monolithic impenetrable even coat. Evaporable solvents lower viscosity and thicken the coating so it may be applied using brushes, rollers, and airless spray equipment to achieve a desired thickness in one coat.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to anticorrosion coatings and particularly to a single-coat self-priming two-component anticorrosion, rust and erosion preventing composition which comprises: a silicone elastomer base of minusil, dimethylpolysiloxane, water, hydrophillic silica and polydimethylsiloxane silanol terminated; a catalyst or curing agent consisting of dibutyl tin bisneodecanoate, ethyl silicate and n-propyl silicate; and a coloring agent which comprises metallic powder ingredients and stearic acid.

2. Description of Related Art Including Information Disclosed Under 37 CFR 1.97 and 1.98

Many outdoor structures require a protective and preventative coating to shield them from the elements. Maintenance of such coatings is often very costly on structures such as bridges, high rise buildings, electric and lamp poles, antennas, cell towers, railroad and subway metals, pilings, wooden structures, underground tunnel structures, swimming pools, water tanks, concrete columns, and manufacturing plants to name a few.

One package organopolysiloxane compositions are known, such as that found in U.S. Pat. No. 4,395,526 by White, which has a condensation catalyst such as a tin compound. The composition presented by White is substantially anhydrous and substantially acid-free, room temperature vulcanizable organopolysiloxane and is stable under ambient conditions in the substantial absence of moisture over an extended period of time and convertible to a tack-free elastomer.

Two-package room temperature vulcanizable silicone rubber compositions are well known and are basically manufactured in two components, one being the base polymer and the other being the catalyst system. Each component is stored separately until it is desired to form the hard elastomeric rubber type of product. When it is desired to cure this system, the polymer base and the catalyst are mixed together, the resulting composition cures to the hard elastomeric state. Such a two-package room temperature vulcanizable silicone rubber composition is described, for instance, in U.S. Pat. No. 2,843,555 by Berridge.

A commonly used coating for bridges and structures near water is a nontoxic silicone-based paint. Normal silicone-based coating requires many layers to make it effective, and therefore it can cost many man hours. Effectiveness may only last up to 5 years at which time recoating is necessary. None of the prior art provides an anticorrosion composition containing a catalyst or curing agent which is easily applied in a single coat with no priming for long term corrosion protection.

U.S. Patent Application #20070218211, published Sep. 20, 2007 by Ahmed, puts forth a method for protecting pipelines and other metal surfaces from corrosion. The metal surface is coated with a vulcanizable elastomeric polyorganosiloxane coating reinforced with geo-tech fabric or any other similar nature fabric or sheeting materials. In a preferred embodiment the geo-tech reinforced silicone provides both cathodic and corrosion protection in submersible underground and overground pipelines. The invention also provides for a method of protecting exposed surfaces particularly metal surfaces more particularly, metal pipelines from the effects of a corrosive environment. The method comprises applying to the surface a thin layer of a vulcanizable elastomeric polyorganosiloxane rubber composition, applying geo-tech or similar fabric onto the wet surface; optionally applying a second application of the same or different vulcanizable elastomeric polyorganosiloxane rubber composition and allowing the composition to cure to a silicone elastomer.

U.S. Patent Application #20070213492, published Sep. 13, 2007 by Mowrer, illustrates silicone-containing coating compositions that include both (a) an alkoxy-functional and/or silanol-functional silicone; and (b) an epoxy-functional silicone. Also disclosed are substrates at least partially coated with a coating deposited from such a composition and methods for coating substrates with such compositions.

U.S. Patent Application #20060058451, published Mar. 16, 2006 by Gommans, shows fast-curing modified siloxane compositions which comprise; (1) an alkoxy- or silanol-functional silicone intermediate, (2) at least one amine reactive ingredient selected from the group consisting of acetoacetate-functional ingredients, acrylate-functional ingredients, and mixtures thereof, (3) an epoxy-functional ingredient, (4) a curing agent selected from the group consisting of amines, aminosilanes, ketimines, aldimines and mixtures thereof, and (5) water. Other ingredients useful in forming fast-curing modified siloxane compositions of this invention include silanes, organometallic catalysts, solvents, pigments, fillers and modifying agents. The above-identified ingredients are combined and reacted to form a fully cured protective film comprising a cross-linked enamine polysiloxane and/or acrylate polysiloxane chemical structure in a reduced amount of time when compared to conventional epoxy siloxane compositions.

U.S. Pat. No. 3,983,265, issued Sep. 28, 1976 to Letoffe, shows a method of coating a substrate with curable organopolysiloxane compositions. The coating is used particularly for electronic connections, but also relates to organopolysiloxane compositions which vulcanize at ambient temperature and above to yield elastomers which adhere, without the aid of an adhesion primer, to the most diverse substrates, for example to metals, to plastics, to wood, to masonry, to ceramics, to glass and to woven and non-woven fibrous materials. Substrates are protected by coating the substrate with a curable organosilicon composition based on .alpha.-.omega.-dihydroxy diorganopolysiloxanes, methyl polysiloxanes, fillers, amino organosilicon cross linking agents and optionally alkyl silicates or polysilicates, which are vulcanizable at ambient temperature or above, are improved by using a methylpolysiloxane in which the ratio of the R(CH.sub.3).sub.2 SiO.sub.0.5 units (R═C.sub.1-C.sub.3 alkyl or vinyl) to SiO.sub.2 units is 0.4:1 to 1.2:1 and which contains 0.5-3.5% by weight OH groups bonded to Si and by using an amino organosilicon compound which is an aminoorganosilane of the general formula (I) (R″O).sub.3.sub.-p R′.sub.p Si[(CH.sub.2).sub.n O].sub.m (CH.sub.2).sub.t NHQ in which R′ represents an alkyl group with 1 to 4 carbon atoms, a vinyl group or a phenyl group, R″ represents a methyl, ethyl or methoxyethyl radical, Q represents a hydrogen atom or the radical—(CH.sub.2).sub.2 NH.sub.2, p and m represent 0 or 1, n represents 1, 2, 3 or 4, and t represents 2 or 3, or an aminoorganopolysiloxane produced by reacting the aminoorganosilane (i) above, in which p is 0, with a hydroxylic methylpolysiloxane polymer (ii) containing at least 2% by weight of hydroxyl groups bonded to the silicon atoms, of viscosity 1 cPo at 25.degree.C. to 1,000 cPo at 25.degree.C., of the average general formula (CH.sub.3).sub.a (HO).sub.b SiO.sub.(4.sub.-a.sub.-b/2) in which a represents any number from 1.6 to 2.3 and b represents any number ranging from 0.1 to 1; the amounts of aminoorganosilane (i) and hydroxylic methylpolysiloxane polymer (ii) being such that there are 0.4 to 1.2 mols of (i) per gram-(hydroxyl group) (that is to say 17 g) of (ii).

U.S. Pat. No. 4,261,758, issued Apr. 14, 1981 to Wright, claims a room temperature vulcanizable silicone rubber composition with sag-control wherein the base material or mixture of ingredients for forming the composition comprises a silanol end-stopped diorganopolysiloxane polymer, at least 3 parts of a fumed silica filler and as the sag-control ingredient, from 0.03 to 2.0 parts of a polyether. As a work-like extending additive in the case of a two-part room temperature vulcanizable silicone rubber composition, there may be added to the basic ingredients of the composition a low viscosity silanol end-stopped polysiloxane. A process is also provided for sealing an area adjacent surface which is selected from the class consisting of plastic surfaces, metal surfaces, masonry surfaces and cellulosic surfaces.

U.S. Pat. No. 4,680,363, issued Jul. 14, 1987 to Beers, describes one component silicone compositions with good bonding properties with an acid scavenger additive for a one-component, acyloxy-functional RTV composition. The acid scavenger is selected from magnesium materials, zinc materials, and aluminum materials. The acid scavenger prevents a discoloration of the metallic substrate and a decrease in bonding properties of the RTV composition to the substrate on which it is applied.

U.S. Pat. No. 7,033,673, issued Apr. 25, 2006 to Wiedemann, discloses erosion-resistant silicone coatings for protection of fluid-handling parts using compositions of silanol and trifunctional silanes. Methods of application, maintenance, and repair of these coatings are also described.

U.S. Pat. No. 7,193,026, issued Mar. 20, 2007 to Itagaki, indicates an organosilicon compound-curing composition and silicone-base coating composition. A curing composition is provided comprising (A) a silane compound having formula: R.sup.1.sub.2Si(OR.sup.2).sub.2 wherein R.sup.1 is C.sub.1 C.sub.3 alkyl, C.sub.2 C.sub.3 alkenyl or phenyl, and R.sup.2 is C.sub.1 C.sub.3 alkyl, C.sub.2 C.sub.3 acyl or C.sub.3 C.sub.5 alkoxyalkyl and (B) phosphoric acid is added to an organosilicon compound to formulate a silicone-base coating composition which remains shelf stable and quickly cures at room temperature after being applied to a substrate, to form a cured coating having transparency, surface hardness, adhesion and the like. A silicone-base coating composition having the curing composition formulated therein is effective as a solventless, room temperature vulcanizable (RTV) silicone coating composition of one part type.

Two U.S. Pat. No. 6,451,437 issued Sep. 17, 2002 and No. 6,723,439 issued Apr. 20, 2004 to Amidaiji, concern a curable composition, coating composition, paint, antifouling paint, cured product thereof and method of rendering base material antifouling. The curable composition comprises (A) an organopolysiloxane having functional groups capable of condensation reaction at both molecular terminals thereof and (B-1) a hydrophobic silica and a hydrophilic silica. A curable composition comprising (A) an organopolysiloxane having functional groups capable of condensation reaction at both molecular terminals thereof and (B-2) a hydrophobic silica, wherein the hydrophobic silica (B-2) is thermally treated together with the organopolysiloxane (A).

U.S. Pat. No. 6,291,021, issued Sep. 18, 2001 to Morita, claims a highly weathering-resistant coating material which exhibits an excellent water resistance and water repellency. The coating material contains a vinyl-type polymer that contains a pendant carbosiloxane dendrimer structure. The coating material is used on construction materials, buildings and structures undercoated with an organic coating material, automobiles, railroad rolling stock, ships, aircraft, and bridges, commercial and industrial plants, and electrical and electronic instruments and devices.

What is needed is a self-priming and elastic preventative and protective coating to keep buildings and structures free from rust, corrosion or erosion for a long period of time. An anticorrosion coating is needed which will not crack or flake and which will show a contrast in color for ease in detecting any rust or corrosion.

### BRIEF SUMMARY OF THE INVENTION

An object of the present invention is to provide a self-priming and elastic preventative and protective coating to keep buildings and structures free from rust, corrosion or erosion for a long period of time, which anticorrosion coating which will not crack or flake and which will show a contrast in color for ease in detecting any rust or corrosion.

In brief, the rust and corrosion prevention coating of the present invention comprises a silicone based elastomer, self priming three component composition that will not crack or flake providing direct adhesion to surface in use requiring high corrosion-resistance performance that is superior to conventional in use with such surface treatment agents such as epoxy, paints, and polymers. The present system of rust-proofing used as provided lasts up to 12 years without total replacement of the coating material.

The present rust and corrosion preventative coating is an elastomer agent with effective qualities that are composed from viscose mass, curing agent, and metallic coloring powders, and may be diluted or thickened depending on solvent agents. This composition consists of three parts of a mixture, and maintains transporting—color properties. Typical chemicals available on the market silicone elastomer based on non-hazardous materials as defined by the OSHA and provided with complete safety data sheets from manufacturers.

Unique inventive color additives are used to create multi-variety of singular color appearance as customized palette for visual, aesthetic effect that would not interfere with the transparency, but is effective in detection of uncoated areas in creating monolithic impenetrable even coat.

Flexibility in variations of needed viscosities is achieved by using evaporable solvents to lower viscosity or thickening the mixture with provided agent, making it possible to use brushes, rollers, or airless spray equipment to achieve approximately 1/32 of an inch, 1/16- 1/18 of an inch thickness in one coat

A curing agent (catalyst) provides excellent balance between pot life and surface application cure that may be increased or decreased in accordance with hot or cold air temperatures, or to speed or slow down curing to benefit the sustaining power of the coating to unusual tilts and difficult structural surfaces such as pipelines (above ground and under ground), oil rig platforms stationed in the open sea, oil and gas tanks, woven canvas and fiber tents and awnings, masonry work, ship interiors and exteriors, radar stations, military and submersible equipment, and railroad stock lumber.

Proposed use of applications of the present invention include as preventive and protective coating from rust, corrosion and erosion in structures including steel, iron, high rise structures, bridges, railroad/subway metal support structures, underground tunnel structures, water tank liners, concrete and cement structural columns and many other structures and surfaces exposed to weather and other hazardous corrosive conditions. Self Priming composition that will not crack or flake under vibration of structure in hot or cold environments. This material will offer 50-75% savings in material and labor costs in the long term use of service. Providing a direct adhesion to surfaces without additional surface priming or painting which will eliminate any special treatments. A single coating alone will provide a full tight protective transparent or semi-colored epidermis that will allow detection and eliminate rust in early stages if there is an incubation of corrosion after the application of this product. The coating has a good smooth, finish which is self leveling and may prevent future settlements, dust accumulations and bird waste which has proven to weaken free standing structures, which can be hosed off, pressure washed with detergents without any damage or chemical effect to the coating for future service to withstand the weather and environmental changes to come.

A primary advantage of the present invention is that it provides a self-priming composition that would not crack or flake under flexion or vibration of structure in hot or cold environments.

Another advantage of the present invention is that it offers approximately 50%-75% savings in material and labor costs in the long term of service, providing direct adhesion to surfaces without additional surface priming which will eliminate any special treatments.

One more advantage of the present invention is that a single coating will provide a fully air-tight, protective, transparent, semi-colored film that will allow detection and eliminate rust appearance in early stages.

A further advantage of the present invention is that it provides abrasive fastening to hardware and structural problems and a self under coat with longer lasting protection in comparison with all existing solid nontransparent coating materials that are used today.

Yet another advantage of the present invention is that it provides a film finish that will allow a see through coating up close or even from a distance (far enough even to view with binoculars) so that it is possible to visually detect if there is any issues under the coated surface such as oxidation or physical changes, or mechanical damages.

Still another advantage of the present invention is that the coating has a good smooth, gloss, and may prevent future settlements, dust accumulation, and bird waste damage to structures, which can be hosed off, pressure washed with detergents without any damage or chemical effect to the coating for future service to withstand the weather and environmental effects.

Other advantages of the coating of the present invention are that it locks tight, blocking any penetration of moisture, chemical elements and oxygen that prevents progression of even entrapped rust particles under the coating of the surface. The efficient continuous film will stop rusting progression in hard to reach places and crevices which may be hard to clean or sand blast off the existing rust.

Coating molecules compromise in flexible but solid film and becomes water, acid or oil insoluble that prevents salt, humidity, moisture, and acid rain total prevention. The clear coating also may be applied over quality base primer rust proof coatings existing on structures or other coating components for their protection from cracking and peeling as protection for conventional protective coat and also through transparency to reveal original prime coat colors.

The coating of the present invention is thermo-resistant with appropriate formulation. The chemical, electronical and mechanical properties of composition remain virtually unchanged throughout various temperatures +500° F. to −160° F. It also has low flammability rating and does not promote toxic combustion by products it is use on. As it contains zero water or water solvents presence in the cured composition in comparison to other coatings with contains asphalt ester compounds for example if they heat at +140° for 30 minutes, the competitor's film will lose a significant amount of cross-linking which will bind, therefore becoming soluble in common solvents and may produce toxic fumes.

### BRIEF DESCRIPTION OF THE SEVERAL VIEWS OF THE DRAWINGS

Not applicable.

### DETAILED DESCRIPTION OF THE INVENTION

The present invention provides a corrosion preventive coating requiring no undercoating. The rust and corrosion preventative coating of the present invention is an elastomer agent with effective qualities that are composed from viscose mass, curing agent, and metallic coloring powders, and may be diluted or thickened depending on solvent agents.

The coating comprising in combination:

at least one of the silicone base compound ingredients taken from the list of silicone base compound ingredients comprising MINUSIL, HYDROPHILLIC SILICA, DIMETHYLPOLYSILOXANE, WATER, and POLYDIMETHY ISILOXANE SILANOL TERMINATED;

at least one curing agent catalyst taken from the list of curing agent catalysts comprising DIBUTYL TIN BISNEODECANOATE, ETHYL SILICATE, and N-PROPYL SILICATE; and

at least one metallic powder coloring ingredient taken from the list of metallic powder coloring ingredients comprising COPPER, ZINC, and STEARIC ACID:

the combination of ingredients being mixed together and applied to a surface to protect the surface within a curing time period determined by the proportion of the ingredients and mixing temperature.

The silicon base compound ingredients preferably comprise a combination of 10-35% MINUSIL, 10-40% DIMETHYLPOLYSILOXANE, 0.1-5% WATER, 10-25% HYDROPHILLIC SILICA, and 25-45% POLYDIMETHY ISILOXANE SILANOL TERMINATED.

The curing agent catalyst preferably comprises a combination of 3-7% DIBUTYL TIN BISNEODECANOATE, 5-10% ETHYL SILICATE, and 5-15% N-PROPYL SILICATE.

The metallic powder coloring ingredients preferably comprise a combination of parts by weight of 80+/−5 COPPER, 20+/−5 ZINC, and 0.5-2.0 STEARIC ACID.

The metallic powder coloring ingredients may comprise a plurality of shades in various combinations to produce alternately semi-transparent coatings, clear coatings, and solid color coatings in different shades and colors.

Color additives may be used to create a multi-variety of singular color appearance to detect uncoated areas to assist in creating a monolithic impenetrable even coat.

Evaporable solvents may be added to lower viscosity and thicken the coating so that the coating may be applied using brushes, rollers, and airless spray equipment to achieve a desired thickness in one coat. The composition of the present invention does “not” contain any TITANIUM DIOXIDE, ALUMINUM HYDROXIDE, CILICA, LEAD OXIDE, or any other environmentally unfriendly chemicals.

This composition consists of three parts of a mixture, and maintains transporting—color properties. Typical chemicals available on the market silicone elastomer based on non-hazardous materials as defined by the OSHA and provided with complete safety data sheets from manufacturers.

The standard silicone-base compound ingredients preferably comprise: MINUSIL 10-35% (CAS# 14808-60-7), DIMETHYLPOLYSILOXANE 10-40% (CAS# 63148-62-9), WATER 0.1-5% (CAS# 7732-18-5), HYDROPHILLIC SILICA 10-25% (CAW 112945-52-5), POLYDIMETHY ISILOXANE SILANOL TERMINATED 25-45% (CAS# 7013-67-8).

The curing agent preferably comprises three catalyst ingredients: DIBUTYL TIN BISNEODECANOATE 3-7% (CAM 68928-76-7), ETHYL SILICATE 5-10% (CAS# 78-1 04), N-PROPYL SILICATE 5-15% (CAS# 682-0 1-9).

The metallic powder coloring ingredients preferably comprise by weight: COPPER 80+/−5 (CAS# 7440-60-8), TLV/TWA=IMG/M3, ZINC 20+/−5 (CAM 7440-60-6), TLV/TWA=IMG/M3, STEARIC ACID 0.5-2.0 (CAS# 57-1-1) TLV/TWA=NON composition have virtually no shrinking. The substance is composed for confinement and ideal curing by using designated curing agent at a ratio of 100:10 at +75° F. for 4-6 hour pot life for maintenance of properties.

The composition may also be used in semi-transparent, clear and solid colors which are achieved with metallic powders in 30 different shades. The importance of this mixture is in the variety of color which allows itself to be distinguished from the film and that of the original structure and which will not shade or block visibility of occurrences over time or distortion, rusting and structural changes in coated structure.

A curing agent (catalyst) provides excellent balance between pot life and surface application cure that may be increased or decreased in accordance of hot or cold air temperatures, or to speed or slow down curing to benefit the sustaining power of the coating to unusual tilts and difficult structural surfaces.

The coating composition is mixed together and must be applied within a four to six hour time frame because it goes through a curing cycle and must be applied during the curing cycle. After that it hardens into the coating. Varying the percentage of the curing agent varies the curing time.

The coating is semi-transparent so that you can see if the metal or other surface underneath is corroding or rusting to repair the damage and then recoat it. It can vary in color depending in the metallic powder used.

The coating is self-priming and does not crack or flake under flex or vibration.

In use, the present invention is applied as a preventive and protective coating from rust, corrosion and erosion, in applications including steel and metal (iron), high rise structures and bridges, electric and lamp poles, antennas, railroad and subway metals, and wooden structures, underground tunnel structures, moisture and termite damage prevention of electric and cable carriers, wood poles, fences, outside and inside water tank liners, concrete and cement columns, bridge structures preventing water and ice damage, basements, basins, swimming pools, inner lining of septic and cesspool tanks, cement mixing equipment, trucks, salt spreading equipment and trucks, roofing, siding, children's playground structures, decorative structures, chemical plant equipment, car wash, boat bottoms, electric generators, water pumps, and such materials as copper, aluminum, steel, iron, zinc, wood, concrete, cements, ceramics.

### Method of Application, Repairing and Removal:

The rust and corrosion protective coating of the present invention has unique features to bind airtight to any smooth or textured surface that is oil, grease, and dust free or even to surfaces with little oil, grease, or dust in a nonpermanent attachment of airtight film, to structures made of steel, iron, aluminum, copper, wood, cement, and glass, which prevents moisture penetration.

Recommended preparations of working surfaces include cleaning or degreasing, using detergents or water-based solvents, sanding with abrasives, sandblasting or applying over a quality existent prime coat, although the composition does not require any priming, because it is a self-priming coat. The mix of catalyst and thickening agent must be adjusted and used in accordance with environmental conditions and structural complexity to prolong pot life or speed application curing time on specific structural surfaces. An increase of viscosity is helpful in creating desired film thickness, and drip and run-free coating. Simplicity of mixing the material for application makes the coating compound easy to use by any qualified structural or maintenance crew member.

Premixed or custom coloring is preferable to use to contrast with existing working surfaces' colors, where contact will help to avoid blank, mis-coated areas. The desired finish is very smooth and can be achieved by repeated soft brush strokes dipped in the solvent over a fresh coating. On the tops of flat sections of a particular structure, which may be used for maintenance trafficking, or on the under cuts that may shelter bird nests, it is recommended to use thick or repeated coatings ⅛-¼″ thick to prevent any mechanical damage from bird droppings' acid effects. The long-lasting life of the coating was verified in experiments that showed that a single coat of the compound maintains its protective properties up to ±12 years without total removal or recoating, with possible minor restoration for accidental abrasions and direct mechanical damage that may create spot cuts or scraping of the film.

The method of applying the present invention to obtain an adequate film formation is not limited to air temperature rangers, but is preferable between −10° F. to +110° F. The most ideal use is that of +70° F. Colder weather has the tendency to slow down the curing process and higher temperatures accelerate. The coating cures are safe to touch, usually in 6-12 hours and have immediate weather and U.V. resistance.

Detected damaged to the film is easily repaired on location without stripping or removing the entire coating. If the coating is permanently bonded to surface (as may occur with some alloys and types of wood), then abrasive sanding of the coating is required. If the coating is not permanently bonded to the surface then the film can be cut out with a blade around the problem areas, peeled off for restoration of damage, e.g., rusted areas, or to replace joints on the hardware in question. For cleaning the area of rust, abrasive sanding or sandblasting may be used. Direct-sandblasting would not damage the surrounding areas of the film if the air flow is prevented from penetrating under the coat by tilting the nozzle away from the cut out edges. When dust is removed and the remaining coat has been cleaned with a solvent, a fresh coat may be applied. Overlapping the cutout areas approximately 2-3 inches is advisable to achieve a permanent bond with the remaining unaltered coating for a solid, continuous, impenetrable, self-adhesion to the oil-free coating. This coating has unique characteristics that are superior to other existing mainstream conventional coatings currently used in rust-proofing of various surfaces.

The present invention has been tested and proven effective.

### Test I.

Acid resistance test was performed with partly coated steel properties. The same sample was dipped for a span of 48 hours in different acids such as 75% Sulfur Acid, 50% Hydrochloric Acid, 32% Muriatic Acid, Assorted Alkaline, Mixed Sodium and diluted Salt and Sulfates. The average length of probing time was 4,320 hours per test. The preserved sample shows slight stain on the transparent surface containing coating with zero penetration or damage to the protective film and the unprotected exposed steel shows substantial rusting damage and corrosion marks on the exposed steel surface. The coating film maintained flexibility and its physical properties virtually remained unchanged with 100% preservation of coated surface from rust.

### Test 2.

Steel and iron samples with partial coating of the composition were placed in acetone and paint thinner mixture containing acetate, methanol, toluene. After 160 hours ⅛″ thick coating shows some partial solution absorption and 1/32″ thick film partially separated from solute but returned to its normal state in 6 hours releasing absorbed solute that resulted in evaporation.

### Test 3.

Coated steel and iron samples were placed in water with 25% table salt solution for 1500 hours and repeatedly removed every 48 hrs, heated and dried at +140° F. and then placed back in the solution. The tested samples did not show any penetration of the compound film or properties changing; it remained in its original rust and corrosion free appearance.

### Test 4.

Steel fragment with 1/16 of an inch transparent coating film was spot sandblasted for 15 minutes at 90 P.S.I. air pressure. Film surface was not really effected, the blasting created only a matted surface to the coating upon the impacted area without tearing, cracking, or peeling from the steel surface. The sample was recoated with 1/32 of an inch film to restore the transparent vibrancy and gloss to the film and permanent adhesion to the old coating.

### Test 5.

A pressure and impact test was performed on a fragment of iron with 1/16 of an inch coating of the compound. The experiment shows that 280 lbs. of pressure per 6 sq. inches does not leave a mark on the film surface or create a tear. 48 hours of continual pressure of hard objects leave an imprint on the surface, but it returns to its original condition within approximately 6 hours of releasing the pressure of the object. Round objects weighing 3-5 lbs at direct fall from a 12 inch distance had no impact to the film's surface, whereas impact from sharp objects from the same distance left minor cuts or scratches, but when recoated the film restored to original condition without any additional effort.

### Evaluation of Properties Test Sheet:

The rust and corrosion preventative coating of the present invention demonstrated excellent quality in chemical and physical experiments. Tests 1, 2, and 3 showed excellent acid resistance and tight blockage barrier from any moisture penetration to the protected surfaces. Tests 4 and 5 showed in durability and flexibility of the film's protective properties that were restored effortlessly. The rust and corrosion preventative coating has claimed qualities that are unparalleled to other conventional coats, and the proposed rust and corrosion protective and preventative coating is superior.

It is understood that the preceding description is given merely by way of illustration and not in limitation of the invention and that various modifications may be made thereto without departing from the spirit of the invention as claimed.

1. A corrosion preventive coating composition requiring no undercoating, the coating composition comprising in combination:
at least one of the silicone base compound ingredients taken from the list of silicone base compound ingredients consisting of micrometer sized silicone base filler particles, HYDROPHILIC SILICA, DIMETHYLPOLYSILOXANE, and POLYDIMETHYL SILOXANE SILANOL TERMINATED, the silicon base compound ingredients comprising a combination of 10-35% micrometer sized silicone base filler particles, 10-40% DIMETHYLPOLYSILOXANE, 0.1-5% WATER, 10-25% HYDROPHILLIC HYDROPHILIC SILICA, and 25-45% POLYDIMETHY ISILOXANE POLYDIMETHYL SILOXANE SILANOL TERMINATED;
at least one curing agent catalyst taken from the list of curing agent catalysts consisting of DIBUTYL TIN BISNEODECANOATE, ETHYL SILICATE, and N-PROPYL SILICATE; and
at least one metallic powder coloring ingredient taken from the list of metallic powder coloring ingredients consisting of COPPER and ZINC mixed with STEARIC ACID:
the combination of ingredients being mixed together with water and applied to a surface to protect the surface within a curing time period determined by the proportion of the ingredients and mixing temperature.

2. (canceled)

3. The coating composition of claim 1 wherein the curing agent catalyst comprises a combination of 3-7% DIBUTYL TIN BISNEODECANOATE, 5-10% ETHYL SILICATE, and 5-15% N-PROPYL SILICATE.

4. The coating composition of claim 1 wherein the metallic powder coloring ingredients comprise a combination of parts by weight of 80+/−5 COPPER, 20+/−5 ZINC, and 0.5-2.0 STEARIC ACID.

5. The coating composition of claim 9 wherein the metallic powder coloring ingredients comprise a plurality of shades in various combinations to produce alternately semi-transparent coating compositions. clear coating compositions, and solid color coating compositions in different shades and colors.

6. The coating composition of claim 1 further comprising color additives to create a multi-variety of singular color appearance to detect uncoated areas to assist in creating a monolithic impenetrable even coat.

7. The coating composition of claim 1 further comprising evaporable solvents to lower viscosity and thicken the coating so that the coating composition may be applied using brushes, rollers, and airless spray equipment to achieve a protective thickness in one coat.

8. A corrosion preventive coating composition requiring no undercoating, the coating composition comprising in combination:
at least one of the silicone base compound ingredients taken from the list of silicone base compound ingredients consisting of micrometer sized silicone base filler particles, HYDROPHILIC SILICA, DIMETHYLPOLYSILOXANE, and POLYDIMETHYL SILOXANE SILANOL TERMINATED;
at least one curing agent catalyst taken from the list of curing agent catalysts consisting of DIBUTYL TIN BISNEODECANOATE, ETHYL SILICATE, and N-PROPYL SILICATE, the curing agent catalyst comprising a combination of 3-7% DIBUTYL TIN BISNEODECANOATE, 5-10% ETHYL SILICATE, and 5-15% N-PROPYL SILICATE; and
at least one metallic powder coloring ingredient taken from the list of metallic powder coloring ingredients consisting of COPPER and ZINC mixed with STEARIC ACID:
the combination of ingredients being mixed together with water and applied to a surface to protect the surface within a curing time period determined by the proportion of the ingredients and mixing temperature.

9. A corrosion preventive coating composition requiring no undercoating, the coating composition comprising in combination:
at least one of the silicone base compound ingredients taken from the list of silicone base compound ingredients consisting of micrometer sized silicone base filler particles, HYDROPHILIC SILICA, DIMETHYLPOLYSILOXANE, and POLYDIMETHYL SILOXANE SILANOL TERMINATED;
at least one curing agent catalyst taken from the list of curing agent catalysts consisting of DIBUTYL TIN BISNEODECANOATE, ETHYL SILICATE, and N-PROPYL SILICATE, the curing agent catalyst comprising a combination of 3-7% DIBUTYL TIN BISNEODECANOATE, 5-10% ETHYL SILICATE, and 5-15% N-PROPYL SILICATE; and
at least one metallic powder coloring ingredient taken from the list of metallic powder coloring ingredients consisting of COPPER and ZINC mixed with STEARIC ACID:
the combination of ingredients being mixed together with water and applied to a surface to protect the surface within a curing time period determined by the proportion of the ingredients and mixing temperature.
